(19) United States
(12) Patent Application Publication
(10) Pub. No.: US 2025/0205726 A1
(43) Pub. Date: Jun. 26, 2025

(54) Replaceable Cartridge for Coating System

(71) Applicant: Transitions Optical, Ltd., Tuma (IE)

(72) Inventors: Willard Beamer, Palmetto, FL (US); Lawrence M. Minor, McKinney, TX (US); Lex Pace, Largo, FL (US)

(21) Appl. No.: 18/849,611

(22) PCT Filed: Mar. 24, 2022
(86) PCT No.: PCT/EP2022/057841

§ 371 Date: Sep. 23, 2024

(51) Int. Cl. B05B 15/58; B01D 19/00; B05B 9/04

(52) U.S. Cl. CPC B05B 15/58; B01D 19/0042; B05B 9/0409; B05B 9/0413

(57) ABSTRACT

A replaceable cartridge for a coating system includes a reservoir configured for containing a volume of a coating and a recirculation loop having an inlet and an outlet in fluid communication with the reservoir. The cartridge further includes a first pump in fluid communication with the recirculation loop. The first pump is configured for recirculating the coating from the reservoir through the recirculation loop. The cartridge further includes a second pump in fluid communication with the recirculation loop, the second pump being configured to selectively aspirate the coating from the recirculation loop and deliver the coating to a coating device.

### CROSS-REFERENCE TO RELATED APPLICATION

This application is the United States national phase of International Application No. PCT/EP2022/057841 filed Mar. 24, 2022, the disclosure of which is hereby incorporated by reference in its entirety.

### BACKGROUND OF THE INVENTION

### Field of the Invention

The present invention relates to a replaceable cartridge for use with a coating system. In particular, the present invention relates to a replaceable cartridge for use with a coating system, the replaceable cartridge having a reservoir for containing a volume of a coating, a recirculation loop in fluid communication with the reservoir, and a pair of pumps in fluid communication with the recirculation loop.

### Description of the Related Art

With optical articles, such as lenses, one or more surfaces may be subjected to a treatment to enhance the overall performance and function of the optical articles. Examples of such treatments include the formation of one or more coatings on a surface of an optical substrate.

In order to manufacture a coated optical article from an uncoated optical substrate, a variety of manufacturing techniques have been developed. In some processes, an uncoated optical substrate is first washed and dried, after which a coating is applied on at least one surface of the substrate. With coatings that require curing with ultraviolet light, the coated substrate is passed through a curing device having an ultraviolet radiation source. In large scale operations, optical substrates may be processed on an automated production line. Such a production line may have a plurality of processing stations for performing the various operations, including washing, drying, coating, and curing. Typically, a single coating is selected for producing a batch of optical articles.

Due to the batch manufacturing process of large scale operations, it is difficult and time consuming to change the type of coating that is applied to the optical article. It would be desirable to develop a new coating system configured for facilitating the use of a plurality of coatings.

### SUMMARY OF THE INVENTION

In some non-limiting examples or aspects of the present disclosure, provided is a replaceable cartridge for a coating system. The replaceable cartridge may include a reservoir configured for containing a volume of a coating, and a recirculation loop having an inlet and an outlet in fluid communication with the reservoir. The replaceable cartridge further may have a first pump in fluid communication with the recirculation loop. The first pump may be configured for recirculating the coating from the reservoir through the recirculation loop. The replaceable cartridge further may have a second pump in fluid communication with the recirculation loop. The second pump may be configured to selectively aspirate the coating from the recirculation loop and deliver the coating to a coating device.

In some non-limiting examples or aspects of the present disclosure, the first pump may be connected to the recirculation loop between the inlet and the outlet of the recirculation loop. The first pump may be configured for continuously recirculating the coating through the recirculation loop. The first pump may be a diaphragm pump. The first pump may include a housing having a first chamber and a second chamber in fluid isolation from the first chamber via a flexible membrane, and a liquid inlet and a liquid outlet in fluid communication with the first chamber. The liquid inlet may have a liquid inlet check valve and the liquid outlet may have a liquid outlet check valve. The first pump further may include an air inlet and an air outlet in fluid communication with the second chamber. The air inlet may have an air inlet check valve operable between an inlet open position and an inlet closed position and the air outlet having an air outlet check valve operable between an outlet open position and an outlet closed position. The air inlet check valve may be operable between the inlet open position and the inlet closed position independent of operation of the air outlet check valve between the outlet open position and the outlet closed position.

In some non-limiting examples or aspects of the present disclosure, the second pump may be downstream of the first pump. The second pump may be a positive displacement piston pump. The second pump may include a housing having an inlet having an inlet valve, an outlet having an outlet valve, and a pumping chamber between the inlet valve and the outlet valve. The second pump further may include a piston disposed within the pumping chamber and configured for reciprocal movement within the pumping chamber via a drive member.

In some non-limiting examples or aspects of the present disclosure, the replaceable cartridge further may include a filter in fluid communication with the recirculation loop. The filter may be configured for filtering the coating circulating through the recirculation loop. The filter may be downstream of the first pump and upstream of the second pump.

In some non-limiting examples or aspects of the present disclosure, the replaceable cartridge further may include a debubbling system in fluid communication with the recirculation loop. The debubbling system may be configured for removing air bubbles in the coating circulating through the recirculation loop. The debubbling system may be downstream of the first pump and upstream of the second pump.

In some non-limiting examples or aspects of the present disclosure, the replaceable cartridge further may include a frame for mounting the reservoir, the first pump, and the second pump. The frame may include electrical connectors for connecting the first pump and the second pump to the coating system.

A replaceable cartridge for a coating apparatus may be characterized by one or more of the following aspects.

In a first aspect, a replaceable cartridge for a coating system has a reservoir configured for containing a volume of a coating; a recirculation loop having an inlet and an outlet in fluid communication with the reservoir; a first pump in fluid communication with the recirculation loop, the first pump configured for recirculating the coating from the reservoir through the recirculation loop; and a second pump in fluid communication with the recirculation loop, the second pump configured to selectively aspirate the coating from the recirculation loop and deliver the coating to a coating device.

In a second aspect, in the replaceable cartridge for a coating system in accordance with the first aspect, the first pump is connected to the recirculation loop between the inlet and the outlet of the recirculation loop.

In a third aspect, in the replaceable cartridge for a coating system in accordance with the first aspect or the second aspect, the first pump is configured for continuously recirculating the coating through the recirculation loop.

In a fourth aspect, in the replaceable cartridge for a coating system in accordance with any one of the first aspect to the third aspect, the first pump is a diaphragm pump.

In a fifth aspect, in the replaceable cartridge for a coating system in accordance with any one of the first aspect to the fourth aspect, the first pump comprises: a housing having a first chamber and a second chamber in fluid isolation from the first chamber via a flexible membrane; a liquid inlet and a liquid outlet in fluid communication with the first chamber, the liquid inlet having a liquid inlet check valve and the liquid outlet having a liquid outlet check valve; an air inlet and an air outlet in fluid communication with the second chamber, the air inlet having an air inlet check valve operable between an inlet open position and an inlet closed position and the air outlet having an air outlet check valve operable between an outlet open position and an outlet closed position.

In a sixth aspect, in the replaceable cartridge for a coating system in accordance with the fifth aspect, the air inlet check valve is operable between the inlet open position and the inlet closed position independent of operation of the air outlet check valve between the outlet open position and the outlet closed position.

In a seventh aspect, in the replaceable cartridge for a coating system in accordance with any one of one of the first aspect to the sixth aspect, the second pump is downstream of the first pump.

In an eighth aspect, in the replaceable cartridge for a coating system in accordance with any one of the first aspect to the seventh aspect, the second pump is a positive displacement piston pump.

In a ninth aspects, in the replaceable cartridge for a coating system in accordance with any one of the first aspect to the eighth aspect, second pump comprises: a housing comprising an inlet having an inlet valve, an outlet having an outlet valve, and a pumping chamber between the inlet valve and the outlet valve; and a piston disposed within the pumping chamber and configured for reciprocal movement within the pumping chamber via a drive member.

In a tenth aspect, in the replaceable cartridge for a coating system in accordance with any one of the first aspect to the ninth aspect, a filter is provided in fluid communication with the recirculation loop, wherein the filter is configured for filtering the coating circulating through the recirculation loop.

In an eleventh aspect, in the replaceable cartridge for a coating system in accordance with the tenth aspect, the filter is downstream of the first pump and upstream of the second pump.

In a twelfth aspect, in the replaceable cartridge for a coating system in accordance with any one of the first aspect to the eleventh aspect, a debubbling system is provided in fluid communication with the recirculation loop, the debubbling system configured for removing air bubbles in the coating circulating through the recirculation loop.

In a thirteenth aspect, in the replaceable cartridge for a coating system in accordance with the twelfth aspect, the debubbling system is downstream of the first pump and upstream of the second pump.

In a fourteenth aspect, in the replaceable cartridge for a coating system in accordance with any one of the first aspect to the thirteenth aspect, a frame is provided for mounting the reservoir, the first pump, and the second pump.

In a fifteenth aspect, in the replaceable cartridge for a coating system in accordance with the fourteenth aspect, the frame comprises electrical connectors for connecting the first pump and the second pump to the coating system.

The features that characterize the present invention are pointed out with particularity in the claims, which are annexed to and form a part of this disclosure. These and other features of the invention, its operating advantages, and the specific objects obtained by its use will be more fully understood from the following detailed description in which non-limiting examples of the invention are illustrated and described.

### BRIEF DESCRIPTION OF THE DRAWINGS

FIG. 1 is a representative schematic view of a coating system in accordance with some examples of the present disclosure;

FIG. 2 is a representative perspective view of an optical article;

FIG. 3 is a representative schematic view of a coating material storage system for use with a coating system;

FIG. 4 is a perspective view of a replaceable cartridge configured for use with the coating material storage system of FIG. 3;

FIG. 5 is a perspective view of a first pump of the replaceable cartridge shown in FIG. 4;

FIG. 6 is a perspective cross-sectional view of the first pump shown in FIG. 4;

FIG. 7 is a side cross-sectional view of a second pump of the replaceable cartridge shown in FIG. 4.

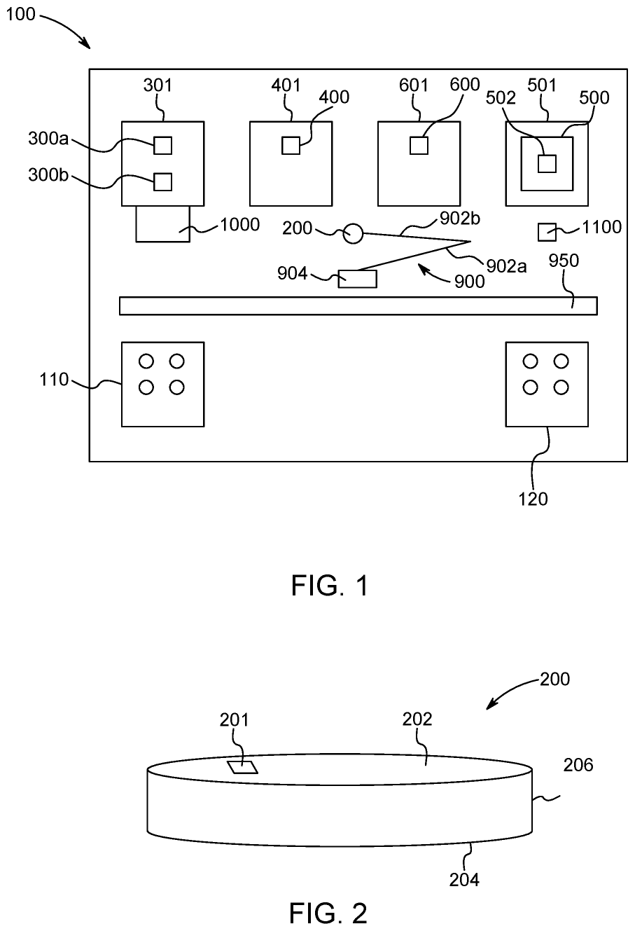

In FIGS. 1-7, like characters refer to the same components and elements, as the case may be, unless otherwise stated.

### DETAILED DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

The term “adjacent” means proximate to but not in direct contact with.

The term “includes” is synonymous with “comprises”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values.

As used herein, the terms “perpendicular” or “substantially perpendicular” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The term “optical” means pertaining to or associated with light and/or vision. For example, an optical element, article, or device can be chosen from ophthalmic elements, articles, and devices; display elements, articles, and devices; visors; windows; and mirrors.

The term “ophthalmic” means pertaining to or associated with the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses, and progressive lenses), as well as other elements used to correct, protect, or enhance (cosmetically or otherwise) vision, including without limitation, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the term “transparent”, such as used in connection with a substrate, film, material, and/or coating, means that the indicated substrate, film, material, and/or coating has the property of transmitting visible light without appreciable scattering so that objects lying beyond are visibly observable.

As used herein, the terms “ultraviolet”, “UV”, “ultraviolet light”, or “ultraviolet radiation” mean electromagnetic radiation having a wavelength in the range of 10 nm to 400 nm.

As used herein, the terms “infrared”, “IR”, “infrared light”, or “infrared radiation” mean electromagnetic radiation having a wavelength in the range of 780 nm to 1 mm.

As used herein, the term “ultrasonic” refers to one or more sound waves having a frequency higher than approximately 20,000 Hz (20 kHz).

As used herein, the term “coating” means a supported film derived from a flowable coating material, which can optionally have a uniform thickness, and specifically excludes polymeric sheets. The terms “layer” and “film” each encompass both coatings (such as a coating layer or a coating film) and sheets, and a layer can include a combination of separate layers, including sub-layers and/or over-layers. The verb “coating” means, within appropriate context, the process of applying a coating material (or materials) to the substrate to form a coating (or coating layer).

As used herein, the terms “cure”, “cured”, and related terms, mean that at least a portion of the polymerizable and/or crosslinkable components that form a curable composition are at least partially polymerized and/or crosslinked. In accordance with some examples, the degree of crosslinking can range from 5% to 100% of complete crosslinking. In accordance with some further examples, the degree of crosslinking can range from 30% to 95%, such as 35% to 95%, or 50% to 95%, or 50% to 85% of complete crosslinking. The degree of crosslinking can range between any combination of these recited lower and upper values, inclusive of the recited values.

As used herein, the terms “communication” and “communicate” may refer to the reception, receipt, transmission, transfer, provision, and/or the like, of information (e.g., data, signals, messages, instructions, commands, and/or the like).

As used herein, a “graphical user interface” or “GUI” refers to a generated display with which a user may interact, either directly or indirectly (e.g., through a button, keyboard, mouse, touchscreen etc.).

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

The invention comprises, consists of, or consists essentially of the following examples of the invention, in any combination. Various examples of the invention may be discussed separately. However, it is to be understood that this is simply for ease of illustration and discussion. In the practice of the invention, one or more aspects of the invention described in one example can be combined with one or more aspects of the invention described in one or more of the other examples.

With reference to FIG. 1, a coating system 100 is shown in accordance with some examples or aspects of the present disclosure. The coating system 100, as described herein, and in accordance with some examples, provides a low cost, small scale coating system configured for applying one or more coating materials to an optical article 200. The coating system 100 can include a surface pretreatment station (such as, but not limited to, a plasma pretreatment station), a washing/drying station, one or more coating apparatuses (utilizing one or more of multiple coatings and combinations of coatings), and one or more curing apparatuses (such as UV, IR, and/or thermal curing apparatuses) or combinations thereof. The coating system 100 of the present invention can, with some examples, be operated with the formation of minimal waste streams and/or waste materials.

The coating system 100 of the present disclosure can, with some examples, be used for the production of optical articles 200, which each independently have the same or different coating materials applied thereon. In some examples, the coating system 100 of the present disclosure can be at least partially automated and optionally incorporated into art-recognized product tracking and control systems.

With reference to FIG. 1, the coating system 100 generally has a plurality of stations, each having an apparatus configured for performing a specified task. For example, the coating system 100 may have a coating station 301 having at least one coating apparatus 300 for coating the optical article 200 and a curing station 401 having at least one curing apparatus 400 for curing the coated optical article 200. Optionally, the coating system 100 has a pre-treatment station 500, and/or a washing and drying station 600. A placement arm 900 may be provided for moving the optical article 200 between various stations of the coating system 100. In some examples or aspects, a conveyor belt 950 may be provided for moving the optical articles 200 between different stations of the coating system 100 or within any single station of the coating system 100.

With continued reference to FIG. 1, the coating system 100 may have a loading station 110 having a plurality of blank optical articles 200 that are to be processed through the coating system 100. The coating system 100 further may include an unloading station 120 configured for storing one or more coated optical articles 200 after the one or more optical articles 200 have been processed through the coating system 100.

The coating system 100 can, with some examples or aspects, be used to coat a variety of articles, such as, but not limited to, optical articles 200. With reference to FIG. 2, the optical article 200 has a forward or top surface 202, a rearward or bottom surface 204, and a side surface 206 extending between the top surface 202 and the bottom surface 204. When the optical article 200 is an ophthalmic lens, the bottom surface 204 is opposed to the eye of an individual wearing the optical article 200, the side surface 206 typically resides within a supportive frame, and the top surface 202 faces incident light (not shown), at least a portion of which passes through the optical article 200 and into the individual's eye. With some examples or aspects, at least one of the top surface 202, the bottom surface 204, and the side surface 206 may have various shapes including, but not limited to, round, flat, cylindrical, spherical, planar, substantially planar, plano-concave and/or plano-convex, and curved, including, but not limited to, convex, and/or concave.

The optical article 200 that is coated with the system and method of the present disclosure can, with some examples, be formed from and correspondingly include organic materials, inorganic materials, or combinations thereof (for example, composite materials).

Examples of organic materials that can be used as optical articles 200 in accordance with various examples of the present invention, include polymeric materials, such as homopolymers and copolymers, prepared from the monomers and mixtures of monomers disclosed in U.S. Pat. Nos. 5,962,617 and in 5,658,501 from column 15, line 28 to column 16, line 17. For example, such polymeric materials can be thermoplastic or thermoset polymeric materials, can be transparent or optically clear, and can have any refractive index required. Examples of such monomers and polymers include: polyol(allyl carbonate) monomers, e.g., allyl diglycol carbonates such as diethylene glycol bis(allyl carbonate), which monomer is sold under the trademark CR-39 by PPG Industries, Inc.; polyurea-polyurethane (polyurea-urethane) polymers, which are prepared, for example, by the reaction of a polyurethane prepolymer and a diamine curing agent, a composition for one such polymer being sold under the trademark TRIVEX by PPG Industries, Inc.; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); poly(vinyl acetate); poly(vinyl alcohol); poly(vinyl chloride); poly(vinylidene chloride); polyethylene; polypropylene; polyurethanes; polythiourethanes; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, and polymers prepared by reacting polyfunctional isocyanates with polythiols or polyepisulfide monomers, either homopolymerized or co-and/or terpolymerized with polythiols, polyisocyanates, and polyisothiocyanates; and optionally ethylenically unsaturated monomers or halogenated aromatic-containing vinyl monomers. Also contemplated are copolymers of such monomers and blends of the described polymers and copolymers with other polymers, for example, to form block copolymers or interpenetrating network products.

With some examples of the present invention, the optical article 200 can be an ophthalmic article. Examples of organic materials suitable for use in forming ophthalmic articles include art-recognized polymers that are useful as ophthalmic articles, such as organic optical resins that are used to prepare optically clear castings for optical applications, such as ophthalmic lenses.

Examples of inorganic materials that can be used as optical articles 200 with some examples of the present invention include glasses, minerals, ceramics, and metals. With some examples, the optical article 200 can include glass. In other examples, the optical article 200 can have a reflective surface, for example, a polished ceramic substrate, metal substrate, or mineral substrate. In other examples, a reflective coating or layer (e.g., a metal layer, such as a silver layer) can be deposited or otherwise applied to a surface of an inorganic or an organic substrate to make it reflective or to enhance its reflectivity.

Optical articles 200 that can be used with the method according to some examples of the present disclosure can also include untinted, tinted, linearly polarizing, circularly polarizing, elliptically polarizing, photochromic, or tinted-photochromic substrates. As used herein with reference to optical articles 200, the term “untinted” means optical articles that are essentially free of coloring agent additions (such as conventional dyes) and have an absorption spectrum for visible radiation that does not vary significantly in response to actinic radiation. Further, with reference to optical articles 200, the term “tinted” means substrates that have a coloring agent addition (such as conventional dyes) and an absorption spectrum for visible radiation that does not vary significantly in response to actinic radiation.

With reference to FIG. 1, a surface-treated and cleaned optical article 200 can be transferred to the coating apparatus 300 for applying one or more coatings to at least one surface of the optical article 200. The coating apparatus 300 may be a plurality of coating apparatuses 300. The one or more coatings may be applied on at least one surface of the optical article 200 using a number of different techniques. In some examples or aspects, the optical article 200 may be immersed into a liquid coating material. After the optical article is pulled out of the liquid, the liquid coating material forms a coating layer on the immersed surface(s) of the optical article 200. In other examples or aspects, as disclosed herein, a liquid coating material is deposited onto a surface of the optical article 200, which is then rotated at high speed to spread the coating material into a thin film covering the surface of the optical article 200. In further examples or aspects, the coating apparatus 300 may be an inkjet printing apparatus that is configured to apply a coating material in the form of extremely fine droplets on a printing surface, such as one or more surfaces of the optical article 200. In various examples or aspects, the coating apparatus 300 may be configured for applying a uniform coating or a gradient coating on at least one surface of the optical article 200.

With reference to FIG. 1, each coating apparatus 300 is in fluid communication with a coating material storage system 1000 (hereinafter referred to as “storage system 1000”). The storage system 1000 is configured for containing the coating material and selectively supplying the coating material to each coating apparatus 300 during a coating application process. In some examples or aspects, the storage system 1000 may contain a single coating material that is selectively supplied to each coating apparatus 300 during the coating application process. In other examples or aspects, the storage system 1000 may contain a plurality of different coating materials, each of which can be independently selected and supplied to each coating apparatus 300 during the coating application process. In this manner, a plurality of coating materials may be supplied to each coating apparatus 300 to create a desired mixture of the coating materials.

The coating material can, with some examples, include a curable resin composition, and optionally, a solvent. The coating material can be in the form of art-recognized liquid coating materials and powder coating materials. The coating material can be thermoplastic, radiation curable such as by ultraviolet radiation or electron beam, or thermosetting coating material. With some examples, the coating materials are selected from curable or thermosetting coating materials. Coating materials can include kinetic enhancing additives, photoinitiators, and thermal initiators. With some examples, coating materials can include a static dye, a photochromic material, or a combination thereof. Alternatively or additionally, the optical article 200 can include a static dye, a photochromic material, or a combination thereof. Various coating materials can be used for applying primer coatings and films; protective coatings and films, including transitional coatings and films and abrasion resistant coatings and films; anti-reflective coatings and films; polarizing coatings and films; and combinations thereof.

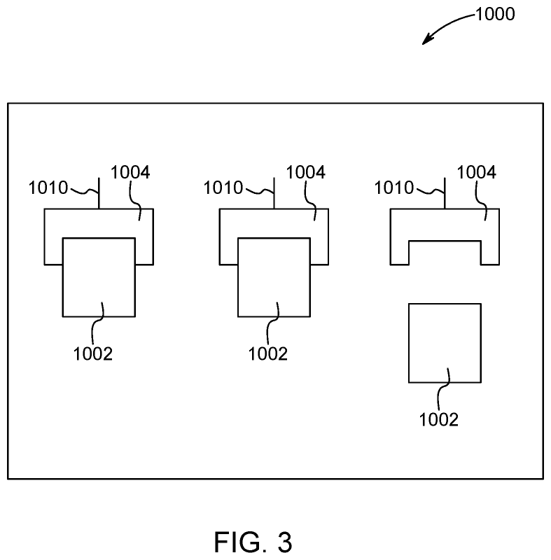

With reference to FIG. 3, the storage system 1000 may have at least one replaceable cartridge 1002. Each replaceable cartridge 1002 of the storage system 1000 may be configured for containing the coating material, recirculating the coating material in a recirculation loop, and selectively dispensing a desired amount of coating material to the coating apparatus 300. In some examples or aspects, a plurality of replaceable cartridges 1002 are provided. Each replaceable cartridge 1002 may contain a different coating material. In some examples or aspects, at least some of the plurality of replaceable cartridges 1002 may contain the same coating material.

With continued reference to FIG. 3, each replaceable cartridge 1002 can be removed from the storage system 1000 for cleaning, refilling, and servicing. For example, the storage system 1000 may have a plurality of bays 1004, each of which is configured to receive a single replaceable cartridge 1002. Each bay 1004 has a first pneumatic connector 1006 and a first electric connector 1008 configured for connecting to the corresponding pneumatic and electric connectors on the replaceable cartridge 1002. In this manner, each replaceable cartridge 1002 can be quickly and easily connected to or disconnected from the respective bay 1004 of the storage system 1000. In some examples or aspects, inserting the replaceable cartridge 1002 into the bay 1004 may automatically establish a pneumatic and electric connection between the replaceable cartridge 1002 and the storage system 1000. In other examples or aspects, pneumatic and electrical connections between the replaceable cartridge 1002 and the bay 1004 can be done separately after inserting the replaceable cartridge 1002 into the bay 1004. Similarly, removing the replaceable cartridge 1002 from the bay 1004 may automatically disconnect the pneumatic and electric connections between the replaceable cartridge 1002 and the storage system 1000. In other examples or aspects, pneumatic and electrical connections between the replaceable cartridge 1002 and the bay 1004 can be disconnected separately prior to or after removal of the replaceable cartridge 1002 from the bay 1004.

With continued reference to FIG. 3, when connected to the bay 1004 of the storage system 1000, each replaceable cartridge 1002 may be fluidly connected to a delivery line 1010 configured to deliver the coating material from the replaceable cartridge 1002 to the at least one coating apparatus 300. In some examples or aspects, each replaceable cartridge 1002, when connected to the respective bay 1004, may be connected to the at least one coating apparatus 300 via a dedicated delivery line 1010. In other examples or aspects, delivery lines 1010 from each replaceable cartridge 1002 may be connected to a manifold that is then connected to the at least one coating apparatus 300.

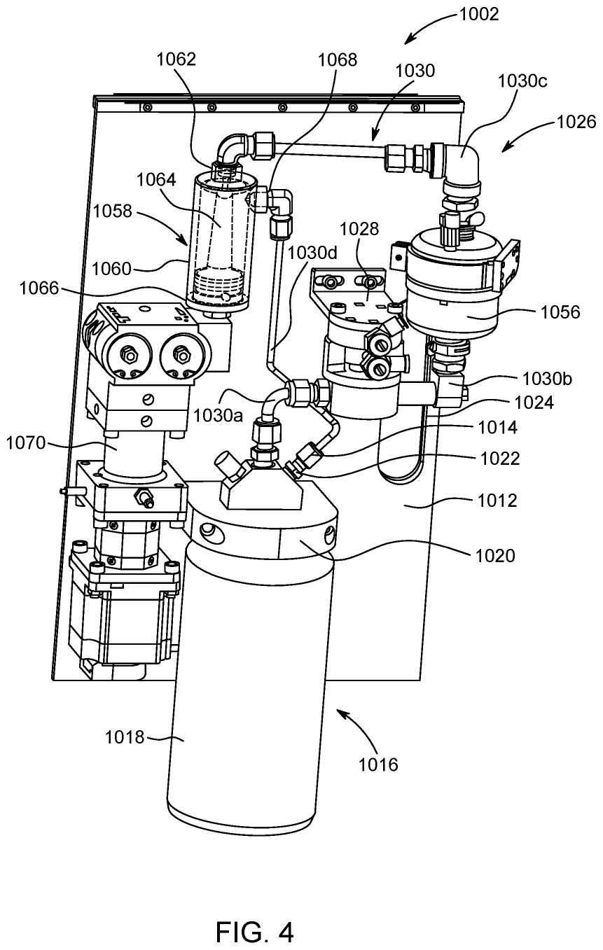

With reference to FIG. 4, the replaceable cartridge 1002 has a frame 1012 configured for supporting various components for containing the coating material, recirculating the coating material in a recirculation loop, and selectively dispensing a desired amount of coating material to the coating apparatus 300. The frame 1012 may be configured to removably or non-removably support the various components. In some examples or aspects, the frame 1012 may be configured for interacting with the bay 1004, such as by having at least one side that is slidably engagable with at least a portion of the bay 1004. The frame 1012 can, in some examples or aspects, be a planar material having a sufficient thickness to support the various components configured for containing the coating material, recirculating the coating material in a recirculation loop, and selectively dispensing a desired amount of coating material to the coating apparatus 300. The frame 1012 can be made from a metal material, a plastic material, or a combination of metal and plastic materials. In some examples or aspects, the frame 1012 may have a handle 1014 for handling the frame 1012 during removal of the frame 1012 from the bay 1004 and/or insertion of the frame 1012 into the bay 1004.

With continued reference to FIG. 4, the replaceable cartridge 1002 has a reservoir 1016 configured for containing a volume of a coating material. In some examples or aspects, the reservoir 1016 has a storage portion 1018 defining an interior for containing the coating material, and a cap 1020 that is removably connectable to the storage portion 1018 and is configured for enclosing the interior of the storage portion 1018. At least one of the storage portion 1018 and the cap 1020 may be removably connected to the frame 1012. In some examples or aspects, the reservoir 1016 may have a volume of 1 L to 20 L. The coating material inside the reservoir 1016 may be kept at ambient pressure, a vacuum pressure, or a positive pressure.

In some examples or aspects, the storage portion 1018 may be a conventional coating reservoir that is provided by a manufacturer of the coating material. Such a storage portion 1018 may be removably connectable to cap 1020. In this manner, the storage portion 1018 may be discarded after the coating material is used up and a new storage portion 1018 filled with the coating material can be connected to the cap 1020. In other examples or aspects, the storage portion 1018 may be re-fillable with the coating material after the coating material is used up.

With continued reference to FIG. 4, the cap 1020 has an outlet 1022 configured for delivering the coating material out of the storage portion 1018 and an inlet 1024 configured for returning the coating material into the storage portion 1018. The outlet 1022 and inlet 1024 are connected to a recirculation loop 1026 that is configured for circulating the coating material from the reservoir 1016 using a first pump 1028. In some examples or aspects, the recirculation loop 1026 comprises tubing 1030 having a first end connected to the outlet 1022 and a second end connected to the inlet 1024. In this manner, the recirculation loop 1026 is in fluid communication with the reservoir 1016. Various additional elements may be disposed in-line with the tubing 1030 between the first end and the second end such that these additional elements are in fluid communication with the recirculation loop 1026, as described herein. When additional elements are provided in-line with the tubing 1030, the tubing 1030 may comprise a plurality of tubing segments interconnecting the various elements and being in fluid communication with each other.

With continued reference to FIG. 4, the replaceable cartridge 1002 has the first pump 1028 in-line with the recirculation loop 1028. The first pump 1028 is connected to the outlet 1022 of the reservoir 1016 via a first tubing segment 1030a. In some embodiments or aspects, the first pump 1028 may be configured to aspirate the coating material from the reservoir 1016 and pump the coating material through the recirculation loop 1026 to be delivered back into the storage portion 1018 via the inlet 1024 or to be delivered to the at least one coating apparatus 300 via a second pump, as described herein. In some examples or aspects, the first pump 1028 may be configured to continuously circulate the coating material through the recirculation loop 1016 while the replaceable cartridge 1002 is connected to the coating system 100. In this manner, the coating material is continuously mixed to prevent separation of solids and to extend the life of the coating material.

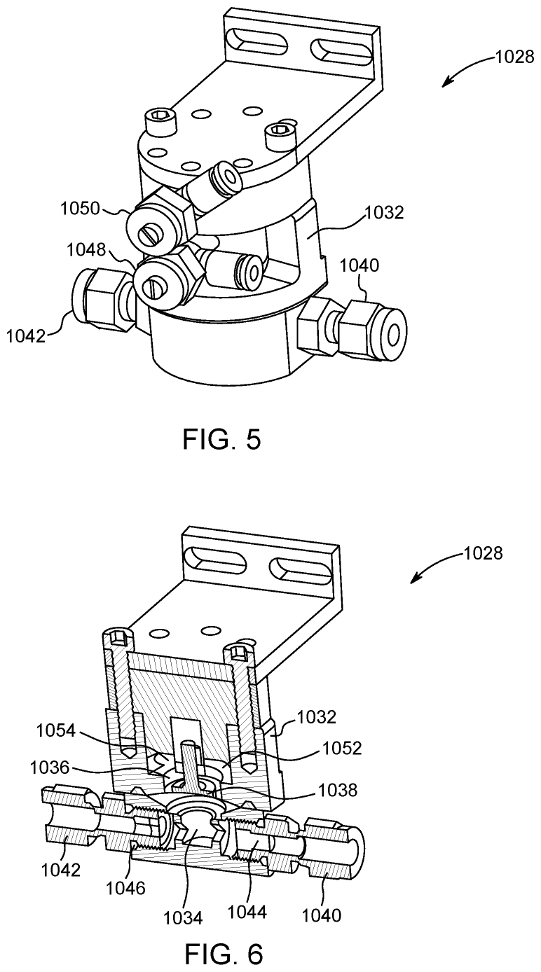

With reference to FIGS. 5-6, the first pump 1028 is a diaphragm pump configured for recirculating the coating material from the reservoir 1016 through the recirculation loop 1026. In some examples or aspects, the first pump 1028 may be any other kind of pump that is configured for continuously recirculating the coating material from the reservoir 1016 through the recirculation loop 1026. When embodied as a diaphragm pump, and as shown in FIG. 6, the first pump 1028 includes a housing 1032 having a first chamber 1034 and a second chamber 1036 in fluid isolation from the first chamber 1034 via a flexible membrane 1038. The flexible membrane 1038 is configured to deflect in response to a pressure differential between the first chamber 1034 and the second chamber 1036. In this manner, by controlling the pressure differential across the chambers 1034, 1036, the first pump 1028 can pump the coating material.

With continued reference to FIGS. 5-6, the first pump 1028 further includes a liquid inlet 1040 and a liquid outlet 1042 in fluid communication with the first chamber 1034. The liquid inlet 1040 has a liquid inlet check valve 1044 and the liquid outlet 1042 has a liquid outlet check valve 1046. The liquid inlet check valve 1044 and the liquid outlet check valve 1046 may be one-way check valves configured to permit flow in a first direction and prevent flow in a second direction opposite to the first direction. The first pump 1028 further includes an air inlet 1048 and an air outlet 1050 in fluid communication with the second chamber 1036. In some examples or aspects, the air inlet 1048 has an air inlet check valve 1052 operable between an air inlet open position and an air inlet closed position and the air outlet 1050 has an air outlet check valve 1054 operable between an air outlet open position and an air outlet closed position. Similar to the liquid inlet and outlet check valves 1044, 1044, the air inlet check valve 1052 and the air outlet check valve 1054 may be one-way check valves configured to permit flow in a first direction and prevent flow in a second direction opposite to the first direction.

In some examples or aspects, the air inlet check valve 1052 may be operable between the air inlet open position and the air inlet closed position independent of operation of the air outlet check valve 1054 between the air outlet open position and the air outlet closed position. For example, a controller 1100 (shown in FIG. 1) may be provided for controlling independent operation of the air inlet check valve 1052 and the air outlet check valve 1054. By controlling the state of the air inlet check valve 1052 and the air outlet check valve 1054, pressure in the second chamber 1036 can be controlled to, in turn, control the position of the flexible membrane 1038. In this manner, by controlling a position of the flexible membrane 1038, liquid coating composition can be pumped through the first chamber 1034.

With reference to FIG. 4, the replaceable cartridge 1002 has a filter 1056 positioned in-line and in fluid communication with the recirculation loop 1028. The filter 1056 may be positioned downstream of the first pump 1028 and may be connected to the liquid outlet 1042 of the first pump 1028 via a second tubing segment 1030b. The filter 1056 may be configured for filtering the coating material circulating through the recirculation loop 1026.

With reference to FIG. 4, the replaceable cartridge 1002 has a de-bubbling system 1058 positioned in-line and in fluid communication with the recirculation loop 1028. The de-bubbling system 1058 may be positioned downstream of the filter 1056 and may be connected to the filter 1056 via a third tubing segment 1030c. The de-bubbling system 1058 may be configured for removing air bubbles in the coating material circulating through the recirculation loop 1026.

With continued reference to FIG. 4, the de-bubbling system 1058 has a chamber 1060 configured for receiving the coating material from the filter 1056 via the third tubing segment 1030c. The third tubing segment 1030c may be connected to a first end 1062 of the chamber 1060. A conical separator 1064 is positioned within the chamber 1060 and is configured for attracting any air bubbles in the coating material as the coating material flows down the conical separator 1064. The attracted air bubbles are dislodged from the conical separator 1064 and float toward the first end 1062 of the chamber 1060. A second end 1066 of the chamber 1060 is positioned at an inlet of the second pump, as described herein. As the coating material fills the chamber 1060, the level of the coating material in the chamber 1060 rises in a direction from the second end 1066 toward the first end 1062. A chamber outlet 1068 is provided in a sidewall of the chamber 1060 proximate to the first end 1062. The chamber outlet 1068 is in fluid communication with the reservoir 1026 via a fourth tubing segment 130d. In this manner, de-bubbled coating material can be returned from the de-bubbling system 1058 into the reservoir 1026 via the fourth tubing segment 1030d.

With continued reference to FIG. 4, the replaceable cartridge 1002 has a second pump 1070 positioned in-line and in fluid communication with the recirculation loop 1028. The second pump 1070 is connected to the second end 1066 of the de-bubbling system 1058 and is configured to aspirate the coating material from the chamber 1060 of the de-bubbling system 1058. In some embodiments or aspects, the second pump 1070 is operable to aspirate a select amount of the coating material from the recirculation loop 1026, such as from the de-bubbling system 1058, and deliver the select amount of the coating material to the at least one coating apparatus 300.

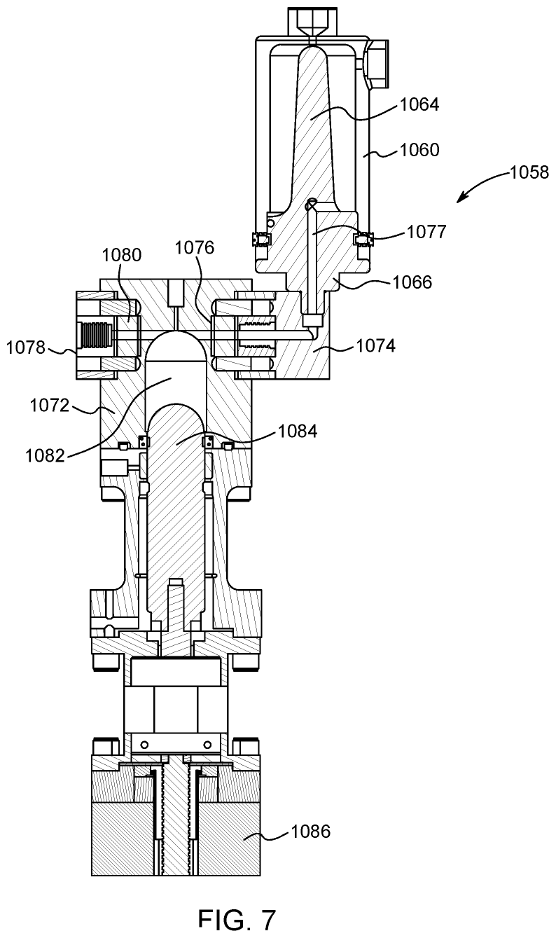

With reference to FIG. 7, the second pump 1070 may be a piston pump. In some examples or aspects, the second pump 1070 may be any other kind of pump that is configured for aspirating a select amount of the coating material from the recirculation loop 1026 and delivering the coating material to the at least one coating apparatus 300. When embodied as a piston pump, the second pump 1070 includes a housing 1072 having an inlet 1074 with an inlet valve 1076, an outlet 1078 having an outlet valve 1080, and a pumping chamber 1082 between the inlet valve 1076 and the outlet valve 1080. The inlet valve 1076 is in fluid communication with the recirculation loop 1026, such as via an inlet tube 1077 connected to the de-bubbling system 1058 while the outlet valve 1080 is in fluid communication with the at least one coating apparatus 300. The piston pump 1070 further includes a piston 1084 disposed within the pumping chamber 1082 and configured for reciprocal movement within the pumping chamber 1082 via a drive member 1086. The drive member 1086 may include an actuator configured for reciprocally moving the piston 1084. In some examples or aspects, the actuator may be a stepper motor. A controller may be configured to control operation of the actuator to accurately dispense a select amount of the coating material from the recirculation loop 1026 and deliver the coating material to the at least one coating apparatus 300. In some examples or aspects, each replaceable cartridge 1002 may have various additional devices, such as heaters, mixers, or the like, may be associated with each replaceable cartridge 1002 for preparing the coating material prior to delivery to the at least one coating apparatus 300.

With reference to FIG. 1, the coating system 100 has at least one controller 1100 operatively connected to at least one component of the coating system 100. In some examples or aspects, the at least one controller 1100 may be configured to control operation of at least one component of the coating apparatus 300, the curing apparatus 400, the pre-treatment station 500, the washing and drying station 600, the placement arm 900, and the at least one replaceable cartridge 1000. In other examples or aspects, separate controllers 1100 may be provided for each of the coating apparatus 300, the curing apparatus 400, the pre-treatment station 500, the washing and drying station 600, the placement arm 900, and the at least one replaceable cartridge 1000.

In some examples or aspects, the at least one controller 1100 may be a microprocessor controller. The at least one controller 1100 may be configured for pulse width modulated (PWM) operation, wherein analog operation of at least one component of the coating apparatus 300, the curing apparatus 400, the pre-treatment station 500, the washing and drying station 600, the placement arm 900, and the at least one replaceable cartridge 1000 can be achieved using digital control signals. In some examples or aspects, the at least one controller 1100 may be configured for continuously modulated control of at least one component of the coating apparatus 300, the curing apparatus 400, the pre-treatment station 500, the washing and drying station 600, the placement arm 900, and the at least one replaceable cartridge 1000. The at least one controller 1100 may have memory configured for storing one or more predetermined automated processes. In some examples or aspects, the at least one controller 1100 may be configured for operating on a 110V or a 220V AC power circuit, and/or on battery power. In other examples or aspects, the at least one controller 1100 may be configured for operating on a 12V DC power circuit.

The present invention has been described with reference to specific details of particular examples thereof. It is not intended that such details be regarded as limitations upon the scope of the invention except insofar as and to the extent that they are included in the accompanying claims.

1. A replaceable cartridge for a coating system, the replaceable cartridge comprising:
a reservoir configured for containing a volume of a coating;
a recirculation loop having an inlet and an outlet in fluid communication with the reservoir;
a first pump in fluid communication with the recirculation loop, the first pump configured for recirculating the coating from the reservoir through the recirculation loop; and
a second pump in fluid communication with the recirculation loop, the second pump configured to selectively aspirate the coating from the recirculation loop and deliver the coating to a coating device.

2. The replaceable cartridge according to claim 1, wherein the first pump is connected to the recirculation loop between the inlet and the outlet of the recirculation loop.

3. The replaceable cartridge according to claim 1, wherein the first pump is configured for continuously recirculating the coating through the recirculation loop.

4. The replaceable cartridge according to claim 1, wherein the first pump is a diaphragm pump.

5. The replaceable cartridge according to claim 1, wherein the first pump comprises:
a housing having a first chamber and a second chamber in fluid isolation from the first chamber via a flexible membrane;
a liquid inlet and a liquid outlet in fluid communication with the first chamber, the liquid inlet having a liquid inlet check valve and the liquid outlet having a liquid outlet check valve;
an air inlet and an air outlet in fluid communication with the second chamber, the air inlet having an air inlet check valve operable between an inlet open position and an inlet closed position and the air outlet having an air outlet check valve operable between an outlet open position and an outlet closed position.

6. The replaceable cartridge according to claim 5, wherein the air inlet check valve is operable between the inlet open position and the inlet closed position independent of operation of the air outlet check valve between the outlet open position and the outlet closed position.

7. The replaceable cartridge according to claim 1, wherein the second pump is downstream of the first pump.

8. The replaceable cartridge according to claim 1, wherein the second pump is a positive displacement piston pump.

9. The replaceable cartridge according to claim 1, wherein the second pump comprises:
a housing comprising an inlet having an inlet valve, an outlet having an outlet valve, and a pumping chamber between the inlet valve and the outlet valve; and
a piston disposed within the pumping chamber and configured for reciprocal movement within the pumping chamber via a drive member.

10. The replaceable cartridge according to claim 1, further comprising a filter in fluid communication with the recirculation loop, wherein the filter is configured for filtering the coating circulating through the recirculation loop.

11. The replaceable cartridge according to claim 10, wherein the filter is downstream of the first pump and upstream of the second pump.

12. The replaceable cartridge according to claim 1, further comprising a debubbling system in fluid communication with the recirculation loop, the debubbling system configured for removing air bubbles in the coating circulating through the recirculation loop.

13. The replaceable cartridge according to claim 12, wherein the debubbling system is downstream of the first pump and upstream of the second pump.

14. The replaceable cartridge according to claim 1, further comprising a frame for mounting the reservoir, the first pump, and the second pump.

15. The replaceable cartridge according to claim 14, wherein the frame comprises electrical connectors for connecting the first pump and the second pump to the coating system.
